(19) United States
(12) Patent Application Publication
(10) Pub. No.: US 2011/0145069 A1
(43) Pub. Date: Jun. 16, 2011

(54) Targeted Consumer Advertising

(75) Inventors: Erno Tauriainen, Oulu (FI); Ahti Vaisanen, Oulu (FI); Jani Korhonen, Kuopio (FI)

(73) Assignee: CASCARD OY, Oulu (FI)

(21) Appl. No.: 12/964,825

(22) Filed: Dec. 10, 2010

Related U.S. Application Data
(63) Continuation-in-part of application No. 12/635,757, filed on Dec. 11, 2009.

(30) Foreign Application Priority Data
Dec. 11, 2009 (EP) EP09178796.0

(51) Int. Cl. G06Q 30/00

(52) U.S. Cl. 705/14.56; 705/14.58

(57) ABSTRACT

Targeted advertising is disclosed. Advertiser-set targeted consumer advertising is saved with interest, location, and time as selection parameters for the targeted consumer. Immediate consumer-triggered interest information is received from a client apparatus of a consumer, and location information determining the present location of the client apparatus is also received. The immediate consumer-triggered interest information indicates immediate interest of the consumer in some good and/or service and/or brand and resulting from consumer interaction with a user interface of the client apparatus. It is searched, in response to receiving the immediate consumer triggered interest information, for such advertiser-set targeted consumer advertising whose interest selection parameter matches the interest information, whose location selection parameter matches the location information, and whose time selection parameter matches the present time. The found instant targeted consumer advertising is transmitted to the client apparatus.

### CROSS-REFERENCE TO RELATED APPLICATIONS

This application is a continuation-in-part of pending U.S. patent application Ser. No. 12/635,757 filed on Dec. 11, 2009, which is incorporated herein by reference. This application claims priority to European Patent Application No. EP09178796.0 filed on Dec. 11, 2009, which is incorporated herein by reference.

### BACKGROUND

1. Field

The invention relates generally to targeted consumer advertising, and specifically to a server apparatus, a client apparatus, a method, and computer programs used in targeted consumer advertising.

2. Description of the Related Art

Targeted consumer advertising aims at improving the efficiency of the advertising, i.e. an advertisement is ideally delivered only to a consumer interested in the marketed service or product. The motivation to the consumer to receive the targeted advertisement may be increased by paying for the consumer a fee for each received advertisement. As such a concept is relatively recent, further sophistication is desirable.

### SUMMARY

The present invention seeks to provide an improved server apparatus, an improved client apparatus, an improved method, and improved computer programs.

According to an aspect of the present invention, there is provided a server apparatus as specified in claim 1.

According to another aspect of the present invention, there is provided a client apparatus as specified in claim 7.

According to another aspect of the present invention, there is provided a method as specified in claim 8.

According to another aspect of the present invention, there is provided a computer program as specified in claim 14.

According to another aspect of the present invention, there is provided a computer program as specified in claim 15.

### BRIEF DESCRIPTION OF THE DRAWINGS

Embodiments of the present invention are described below, by way of example only, with reference to the accompanying drawings, in which

FIGS. 1A, 1B, and 1C illustrate various embodiments of a targeted advertising system;

FIG. 2 illustrates an example structure of an apparatus;

FIG. 3 illustrates embodiments of a method;

FIG. 4 illustrates consumer-triggered interest information; and

FIGS. 5, 6, and 7 are signal-sequence charts illustrating communication.

### DETAILED DESCRIPTION

The following embodiments are exemplary. Although the specification may refer to “an” embodiment in several locations, this does not necessarily mean that each such reference is to the same embodiment(s), or that the feature only applies to a single embodiment. Single features of different embodiments may also be combined to provide other embodiments.

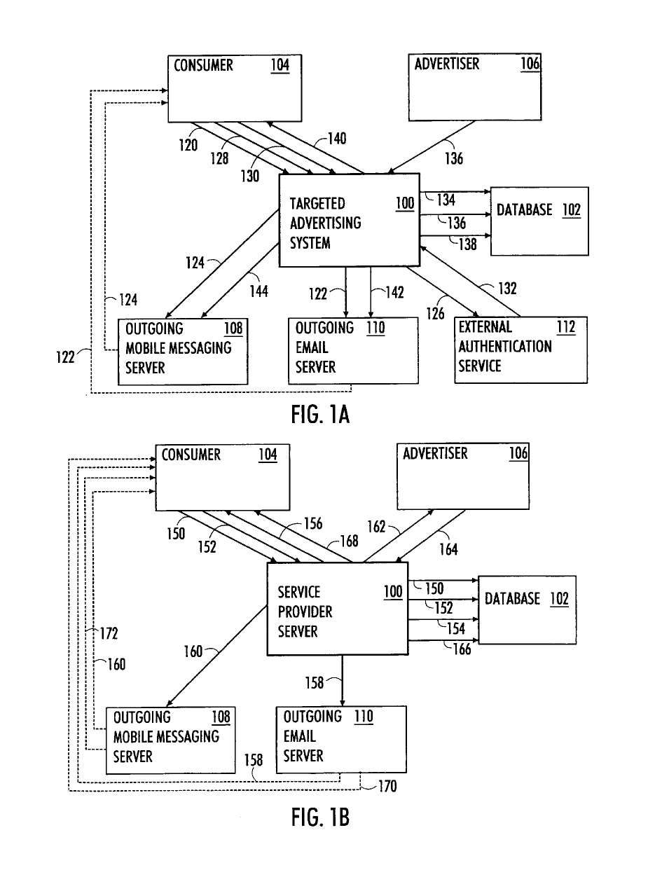

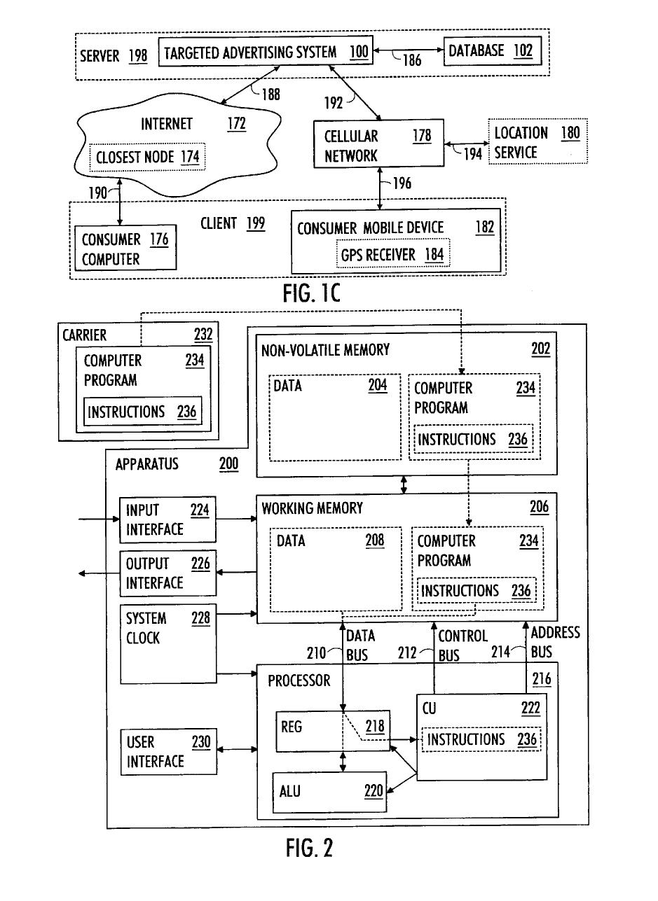

FIGS. 1A, 1B, 1C, and 2 illustrate embodiments of various apparatuses. FIGS. 1A, 1B, 1C, and 2 only show some elements and their implementation may differ from what is shown. The connections shown in FIGS. 1A, 1B, 1C, and 2 are logical connections; the actual physical connections may be different. Interfaces between the various elements may be implemented with suitable interface technologies, such as a message interface, a method interface, a sub-routine call interface, a block interface, or any means enabling communication between functional sub-units. It should be appreciated that the apparatuses may comprise other parts. However, such other parts are irrelevant to the actual invention and, therefore, they need not be discussed in more detail here. It is also to be noted that although some elements are depicted as separate ones, some of them may be integrated into a single physical element. The specifications of the apparatuses may develop rapidly. Such development may require extra changes to an embodiment. Therefore, all words and expressions should be interpreted broadly, and they are intended to illustrate, not to restrict, the embodiments.

With reference to FIG. 1A, an example configuration of a targeted advertising system 100 is described. The targeted advertising system 100 comprises a database 102 and it interacts with consumers 104, advertisers 106, an outgoing mobile messaging server 108, an outgoing email server 110, and an external authentication service 112.

The advertiser 106, i.e. the advertisement provider, may use a web browser over TCP/IP (Transmission Control Protocol/Internet Protocol) to access the targeted advertising system 100.

The consumer 104, i.e. the receiver of the advertisement, may use an email client over TCP/IP, mobile phone with SMS and/or MMS capabilities and/or other instant messaging features, and/or a web browser over TCP/IP to access the targeted advertising system 100.

The targeted advertising system 100 is configured to implement a suitable targeted advertising scheme. Consumers 104 and advertisers 106 are registered in the targeted advertising system 100, whereby information of each consumer 104, each advertiser 106, and each advertisement campaign is stored in a database 102.

The targeted advertising system 100 may be configured to provide various user interfaces. An advertiser user interface is configured to interact with each advertiser 106 in order to produce a suitable targeted advertising campaign by collecting basic information from the advertiser, planning the advertising campaign etc. A consumer user interface is configured to recruit consumers 104 to the system by collecting basic information from the consumer, such as age, sex, place of residence, nationality, language(s), hobbies, interests, consumer habits, etc. An administrator user interface is configured to manage the targeted advertising system 100, i.e. to interact with the advertisers and the customers, plan the campaign in co-operation with the advertiser, implement the pricing and reward schemes etc.

The external authentication service 112 is configured to authenticate the consumer 104, because if each consumer 104 is authenticated, the reliability of the system is improved, i.e. the advertiser 106 is assured that the advertisement is really targeted at true individuals interested in their services or products. Authentication is the act of confirming someone as authentic, i.e. that the claims made by or about the subject are true. The authentication involves confirming the identity of the person. The external authentication service 112 may be a registry maintained by a government authority, population register centre, and/or a service maintained by a bank, or any other authentication service capable of reliably checking the identity of the consumer 104.

In Finland, the consumer 104 may be verified in web-based systems by using commonly used person identification services offered by banks (TUPAS), for example. The downside of that is that not all consumers have access to the TUPAS. Also, the TUPAS only verifies the user and does not create a similar update service as offered by Itella (=national mail enterprise owned by the Finnish state) that provides access to the population register centre.

The outgoing mobile messaging server 108 and/or the outgoing email server 110 may be configured to deliver information received from the targeted advertising system 100 to each consumer 104 through a communication system. The communication system may communicate in a wired or a wireless fashion. Such communication techniques utilize electric and/or magnetic radiation. GSM (Global System for Mobile Communications), WCDMA (Wideband Code Division Multiple Access), WLAN (Wireless Local Area Network) or Bluetooth® are examples of wireless communication standards, but also other standard communication techniques and even non-standard and/or proprietary wireless communication techniques may be used. Naturally, all standard/non-standard wired communication techniques may be used, such as Ethernet, TCP/IP, etc. The communication network may be the Internet, or a part of the Internet, or it may be coupled to the Internet. The protocols used and the specifications of the communication techniques, especially in wireless communication, develop rapidly. Such development may require extra changes to an embodiment. Therefore, all words and expressions should be interpreted broadly and they are intended to illustrate, not to restrict, the embodiment.

The consumer 104 may use a user terminal configured to receive the targeted advertisement from the targeted advertising system 100 through the communication system. The targeted advertisement may be received as an SMS (Short Message Service) message, an MMS (Multimedia Message Service), an electronic mail message, a Twitter tweet, or on a personal page in the web, or in some social media, etc. In all cases, the user terminal may be used to view the targeted advertisement. The user terminal may be a mobile device, which refers to a portable computing device or a computer, such as a desktop computer, a laptop computer, a palmtop computer, a terminal of a computer system, or any other suitable electronic user terminal capable of presenting the targeted advertisement. The mobile device may be a wireless mobile communication device operating with or without a subscriber identification module (SIM), including, but not limited to, the following types of devices: mobile phone, smartphone, personal digital assistant (PDA), handset.

In summary, the consumer 104 indicates her interest areas, whereupon the advertiser 106 may provide targeted advertisement to the consumer 104. In an embodiment, the memory 202/206 and the computer program 234 instructions 236 are further configured to, with the processor 216, cause the apparatus 200 to perform: provide a fee for the authenticated consumer 104 for receiving the targeted consumer advertising utilizing the registered contact information. This may be implemented such that the advertiser 106 may credit the consumer 104 with a small sum of money for receiving the advertisement, i.e. the advertiser 106 makes a micropayment to the consumer 104. A ‘micropayment’ refers to a means for transferring very small amounts of money in situations where collecting such small amounts of money with the usual payment systems is impractical or very expensive in terms of the amount of money being collected. The money sum may be a few Eurocents or even less. The micropayment may be credited to a consumer 104 account such as a personal prepaid card, a personal debit card, a personal credit card, and/or a bank account of the consumer 104. Banque Invik S.A. based in Luxembourg offers a prepaid card, EveryWhereMoney™ account, which may be used in the described targeted advertising system 100. With EveryWhereMoney™ the consumer 104 receives a prepaid account in a currency of her choice with a payment card attached. The payment card is worldwide accepted and may be used to withdraw money and to purchase with merchants or securely in the Internet. As the advertiser 106 pays the consumer-specific micropayment invoice by bank transfer, the sum fixed in the micropayment invoice is transferred to the EveryWhereMoney™ account of the consumer 104.

The targeted advertising system 100 described in FIGS. 1A, 1B, and 1C may be implemented by one or more apparatuses. With reference to FIG. 2, an example structure of an apparatus 200 is described. The apparatus 200 may be a computer, such as at least one server computer used to implement the targeted advertising system 100, or, in the role of the client, a consumer computer 176, or a part of the consumer mobile device 182, for example. The apparatus 200 comprises a processor 216 and a memory 202/206 including computer program 234 instructions 236.

In the server apparatus, the memory 202/206 and the computer program 234 instructions 236 are configured to, with the processor 216, cause the server apparatus to perform: save into the database advertiser-set targeted consumer advertising with interest, location, and time as selection parameters for the targeted consumer; receive immediate consumer-triggered interest information from a client apparatus of a consumer, and receive location information determining the present location of the client apparatus, the immediate consumer-triggered interest information indicating immediate interest of the consumer in some good and/or service and/or brand and resulting from consumer interaction with a user interface of the client apparatus; search, in response to receiving the immediate consumer triggered interest information, from the database for such advertiser-set targeted consumer advertising whose interest selection parameter matches the interest information, whose location selection parameter matches the location information, and whose time selection parameter matches the present time; and transmit the found instant targeted consumer advertising to the client apparatus.

A good may be defined as a physical (tangible) product, capable of being delivered to a purchaser and may involve the transfer of ownership from seller (=advertiser) to customer (=consumer). A service is the intangible equivalent of a good. A brand is a name, sign, symbol, slogan or anything that may be used to identify and distinguish a specific product, service, or business. A simple example will illustrate the differences between these concepts: a car is a good, a car repair is a service, and Volvo® is a well-known car brand.

In the client apparatus, the memory 202/206 and the computer program 234 instructions 236 are configured to, with the processor 216, cause the client apparatus to perform: trigger immediate consumer-triggered interest information relating to the advertiser-set targeted consumer advertising with the user interface; transmit the immediate consumer-triggered interest information to the server apparatus; receive instant targeted consumer advertising from the server apparatus; and present the received instant targeted consumer advertising with the user interface.

In an embodiment, the memory 202/206 and the computer program 234 instructions 236 are further configured to, with the processor 216, cause the server apparatus to perform: register electronically time criteria for the targeted consumer advertising of the authenticated consumer 104; and target the targeted consumer advertising on the authenticated consumer 104 utilizing the registered time criteria. Dynamic time criteria may be a part of the consumer profile. As an example, let us suppose that consumer A sets timed profile settings concerning the following week informing that she will spend the next weekend in city X. The advertiser creates an advertisement based on the consumer location determining that the advertisement is targeted on consumers in city X (among the other targeting criteria). The advertiser sees the amount of potential customers, consumer A being included as one of them, because the advertisement is set to be active during the next weekend and the consumer location criteria matches the location of consumer A during the weekend. Consequently, customer A receives the advertisement during the weekend. The advertisement may advertise a lunch menu of a local restaurant in city X, for example.

Dynamic time criteria may be a part of the consumer profile and also a part of advertisement settings. Again, consumer A sets timed profile settings concerning the following week informing that she will spend the next weekend in city X. The advertiser creates an advertisement based on the consumer location determining that the advertisement is targeted on consumers in city X (among the other targeting criteria), but now the advertiser also sets the time criteria: the advertising starts immediately and the consumer must be in city X during a predetermined time interval. Customer A receives the advertisement as soon as the system has processed it, as her location is city X, and the predetermined time interval includes the next weekend. The advertisement may advertise a local theater show to which tickets need to be booked in advance, for example.

In general, the apparatus 200 may be an electronic digital computer which may comprise, besides the processor 216 and the working memory 206, a system clock 228. Furthermore, the computer 200 may comprise a number of peripheral devices. In FIG. 2, some peripheral devices are illustrated: the non-volatile memory 202, the input interface 224, the output interface 226, and a user interface 230 (such as a pointing device, a keyboard, a display, etc.). The user interface 230 may be used for user interaction, i.e. to implement the user interfaces mentioned in connection with FIG. 1A, for example. Naturally, the computer 200 may comprise a number of other peripheral devices not illustrated here for the sake of clarity.

The system clock 228 constantly generates a stream of electrical pulses, which cause the various transferring operations within the computer 200 to take place in an orderly manner and with specific timing.

Depending on the processing power needed, the computer 200 may comprise several (parallel) processors 216, or the required processing may be distributed amongst a number of computers 200. The computer 200 may be a laptop computer, a personal computer, a server computer, a mainframe computer, or any other suitable computer. As the processing power of portable communications terminals, such as mobile phones, is constantly increasing, the apparatus 200 functionality may be implemented into them as well. Besides the contemporary computers utilizing binary digits, or bits, for presenting data 208 and instructions 236 by the use of the Binary number system's two-binary digits “0” and “1”, the emerging quantum computers may also be used, such quantum computers utilizing quantum bits, or qubits, instead of bits.

The term ‘processor’ refers to a device that is capable of processing data. The processor 216 may comprise an electronic circuit or electronic circuits implementing the required functionality, and/or a microprocessor or microprocessors running computer program 234 instructions 236 implementing the required functionality. When designing the implementation, a person skilled in the art will consider the requirements set for the size and power consumption of the apparatus, the necessary processing capacity, production costs, and production volumes, for example. The electronic circuit may comprise logic components, standard integrated circuits, application-specific integrated circuits (ASIC), and/or other suitable electronic structures.

The microprocessor 216 implements functions of a central processing unit (CPU) on an integrated circuit. The CPU 216 is a logic machine executing computer program 234 instructions 236. The program instructions 236 may be coded as a computer program 234 using a programming language, which may be a high-level programming language, such as C, or Java, or a low-level programming language, such as a machine language, or an assembler. The CPU 216 may comprise a set of registers 218, an arithmetic logic unit (ALU) 220, and a control unit (CU) 222. The control unit 222 is controlled by a sequence of program instructions 236 transferred to the CPU 216 from the working memory 206. The control unit 222 may contain a number of microinstructions for basic operations. The implementation of the microinstructions may vary depending on the CPU 216 design. The microprocessor 216 may also have an operating system (a general purpose operating system, a dedicated operating system of an embedded system, or a real-time operating system, for example), which may provide the computer program 234 with system services.

There may be three different types of buses between the working memory 206 and the processor 216: a data bus 210, a control bus 212, and an address bus 214. The control unit 222 uses the control bus 212 to set the working memory 206 in two states, one for writing data into the working memory 206 and the other for reading data from the working memory 206. The control unit 222 uses the address bus 214 to send to the working memory 206 address signals for addressing specified portions of the memory in writing and reading states. The data bus 210 is used to transfer data 208 from the working memory 206 to the processor 216 and from the processor 216 to the working memory 206, and to transfer the instructions 236 from the working memory 206 to the processor 216.

The working memory 206 may be implemented as a random-access memory (RAM), where the information is lost after the power is switched off. The RAM is capable of returning any piece of data in a constant time, regardless of its physical location and whether or not it relates to a previous piece of data. The data may comprise data 208 relating to targeted advertising, personal identification and contact information of the consumer 104, any temporary data needed during the processing, and computer 234 program instructions 236 etc.

The non-volatile memory 202 retains the stored information even when not powered. Examples of non-volatile memory include read-only memory (ROM), flash memory, magnetic computer storage devices, such as hard disk drives, and optical discs. As is shown in FIG. 1A, the non-volatile memory 110 may store both data 204 relating to targeted advertising, personal identification and contact information of the consumer 104, and computer program 234 instructions 236.

An embodiment provides a non-transitory computer-readable storage medium storing a computer program 234 comprising computer program instructions 236 which, when loaded into the server apparatus, cause the server apparatus to perform: save advertiser-set targeted consumer advertising with interest, location, and time as selection parameters for the targeted consumer; receive immediate consumer-triggered interest information from a client apparatus of a consumer, and receive location information determining the present location of the client apparatus, the immediate consumer-triggered interest information indicating immediate interest of the consumer in some good and/or service and/or brand and resulting from consumer interaction with a user interface of the client apparatus; search, in response to receiving the immediate consumer triggered interest information, for such advertiser-set targeted consumer advertising whose interest selection parameter matches the interest information, whose location selection parameter matches the location information, and whose time selection parameter matches the present time; and transmit the found instant targeted consumer advertising to the client apparatus.

Another embodiment provides a non-transitory computer-readable storage medium storing a computer program 234 comprising computer program instructions 236 which, when loaded into the client apparatus, cause the client apparatus to perform: trigger immediate consumer-triggered interest information relating to the advertiser-set targeted consumer advertising with a user interface; transmit the immediate consumer-triggered interest information to a server apparatus; receive instant targeted consumer advertising from the server apparatus; and present the received instant targeted consumer advertising with the user interface.

The computer program 234 may be in a source code form, object code form, or in some intermediate form. The computer program 234 may be stored in a carrier 232, which may be any entity or device capable of carrying the program to the apparatus 200. The carrier 232 may be implemented as follows, for example: the computer program 234 may be embodied, besides computer-readable storage medium, on a record medium, stored in a computer memory, embodied in a read-only memory, carried on an electrical carrier signal, carried on a telecommunications signal, and/or embodied on a software distribution medium. In some jurisdictions, depending on the legislation and the patent practice, the carrier 232 may not be the telecommunications signal.

FIG. 2 illustrates that the carrier 232 may be coupled to the apparatus 200, whereupon the program 234 comprising the program instructions 236 is transferred into the non-volatile memory 202 of the apparatus 200. The program 234 with its program instructions 236 may be loaded from the non-volatile memory 202 into the working memory 206. During running of the program 234, the program instructions 236 are transferred via the data bus 210 from the working memory 206 into the control unit 222, wherein usually a portion of the instructions 236 resides and controls the operation of the apparatus 200.

There are many ways to structure the program 234. The operations of the program may be divided into functional modules, sub-routines, methods, classes, objects, applets, macros, etc., depending on the software design methodology and the programming language used. In modern programming environments, there are software libraries, i.e. compilations of ready made functions, which the program may utilize for performing a wide variety of standard operations.

Besides the basic entities described earlier, there may be a number of other, supplementary entities. Data 208, which comprises data relating to targeted advertising, personal identification and contact information of the consumer 104, may be brought into the working memory 206 via the non-volatile memory 202 or via the input interface 224. There may exist a further software entity for this operation. The data 204 may have been brought into the non-volatile memory 202 via a memory device (such as a memory card, an optical disk, or any other suitable non-volatile memory device) or via a telecommunications connection (via Internet, or another wired/wireless connection). The input interface 224 may be a suitable communication bus, such as USB (Universal Serial Bus) or some other serial/parallel bus, operating in a wireless/wired fashion. The input interface 224 may be directly coupled to an electronic system, or there may be a telecommunications connection between the input interface 224 and the electronic system.

In summary, the described targeted advertising system 100 provides an electrical channel (e.g. web-pages, email, instant messages, Internet-based unidirectional information feeds and messages to mobile devices) for advertisers 106 to target consumers 104 based on the pre-conditions set by the consumer 104. Specifically, the consumers 104 may have registered into the system so that the following combined verifications may be used: their personal identification (name, birth date and address) have been automatically authenticated from the external authentication service 112; and their phone numbers and email addresses are verified by sending them a personal probe messages asking the consumers 104 to confirm that they received the information correctly.

The personal information authentication is performed when the consumer 104 for the first time signs in to the targeted advertising system 100. The external authentication service 112 may send address updates and the status of the person (e.g. deceased) to the targeted advertising system 100 automatically. The authentication happens automatically online. If the information on the consumer 104 does not pass the authentication, an administrative user of the targeted advertising system 100 may manually approve the registration by using authentication methods outside of the scope of this system. When the registration and authentication are completed, the consumer 104 has access to the targeted advertising system 100 and may control his/her personal account in the system. The account may then be used to access the targeted advertisements and to set the pre-conditions under which the consumer is prepared to receive advertisements. Especially, the created account has now been securely authenticated against the external authentication service 112 and, consequently, the targeted advertising system 100 is only accessible by authenticated consumers 104.

The targeted advertising system 100 enables the consumer 104 to enter criteria for receiving electrical advertisements. As a user of the system, the consumer 104 may set into the targeted advertising system 100 various profile based information which may be used by the targeted advertising system 100 to limit the advertising to only those consumers 104 who have a fully or partly matching profile. Specifically, the targeted advertising system 100 enables the consumer 104 to adjust the criteria according to time. This means that the consumer 104 may change anytime the criteria which controls in real-time which advertisements are being delivered to the consumer 104. The consumer 104 may also set specific future time periods, which will be activated in due time. Such future criteria may be used in two ways: to trigger the sending of the electrical advertisement in a time moment in the future or to send the advertisement before the criteria time period, so that the advertisement content is tailored to meet the future criteria.

The targeted advertising system 100 offers higher advertisement value to the service provider by offering channels to the authenticated consumers 104. This value is further enhanced by allowing the consumer 104 to set criteria for receiving the advertisements. By allowing the consumer 104 to change the criteria in real-time and to set future time periods, the targeted advertising system 100 actually makes it possible for the consumers 104 to preprogram how they will receive electrical advertisements and with what content.

If the time-based criteria and the possibility to alter the criteria were left out of the system, the consumers 104 would have a fixed set of criteria. This would work for some time, but as consumer's need for commercial information changes, the fixed criteria would match with advertisements the consumer 104 is no longer interested in. This would lead to a weakened advertisement value.

If the criteria settings were left out totally, the consumers 104 would receive non-targeted mass advertisement which has the highest weakening impact on the advertisement value.

In principle, it could also be possible for the consumers 104 to give their criteria directly to the advertisers 106 without the targeted advertising system 100 in between. However, consumers 104 in general are not willing to do that. Additionally, the consumers 104 would in that case give the information to multiple places, whereas with the targeted advertising system 100 they may update their information to one place and still maintain their anonymity towards the advertisers 106.

Next, with reference to FIG. 1A, authentication of the consumer 104 is explained as a message flow between various actors.

The consumer 104 enters 120 the personal contact information into the targeted advertising system 100 (using IP/TCP/HTTP protocols, for example).

An email is sent out 122 from the targeted advertising system 100 through the outgoing email server 110 to be verified by the consumer 104.

A mobile message is sent out 124 from the targeted advertising system 100 through the outgoing mobile messaging server 108 to be verified by the consumer 104 (using GSM and IP/TCP protocols, for example).

Name, address and birth date of the consumer 104 are verified 126 against the external authentication service (using IP/TCP/HTTP protocols, for example).

The consumer 104 confirms 128 the email into the targeted advertising system 100 (using IP/TCP/HTTP protocols, for example).

The consumer 104 confirms 130 the mobile message into the targeted advertising system 100 (using IP/TCP/HTTP protocols, for example).

The external authentication service 112 confirms 132 the name, address and birth date of the consumer 104 into the targeted advertising system 100 (using IP/TCP/HTTP protocols, or IP/TCP/FTP protocols, for example).

A consumer account is created 134 into the database 102.

The advertiser 106 enters 136 an electrical advertisement into the targeted advertising system 100 (using IP/TCP/HTTP protocols, for example).

The targeted advertising system 100 matches 138 the existing advertisements against the verified consumer's account in the database 102.

The targeted advertising system 100 displays 140 the advertisement in the consumer's personal web user interface (using IP/TCP/HTTP protocols, for example).

The targeted advertising system 100 sends 142 out the advertisement content over email (using IP/TCP protocols, for example).

The targeted advertising system 100 sends out 144 the advertisement content over mobile messaging (using GSM and IP/TCP protocols, for example).

Next, with reference to FIG. 1B, setting of the consumer 104 specific criteria is explained as a message flow between various actors.

The consumer 104 logs 150 in to the targeted advertising system 100 (using IP/TCP/HTTP protocols, for example).

The consumer 104 changes 152 the personal criteria for receiving the advertisements (using IP/TCP/HTTP protocols, for example).

The targeted advertising system 100 matches 154 the existing advertisements against the verified consumer's account (using a database connection over TCP, for example).

The targeted advertising system 100 displays 156 the advertisement in the consumer's personal web user interface (using IP/TCP/HTTP protocols, for example).

The targeted advertising system 100 sends 158 out the advertisement content over email (using IP/TCP protocol, for example).

The targeted advertising system 100 sends 160 out the advertisement content over mobile messaging (using GSM and IP/TCP protocols, for example).

The advertiser 106 sees 162 from the targeted advertising system 100 web user interface that there has been a change in the receiving criteria settings (using IP/TCP/HTTP protocols, for example).

The advertiser 106 adds 164 new advertisement content to the targeted advertising system 100, the new content matching the changed criteria settings (using IP/TCP/HTTP protocols, for example).

The targeted advertising system 100 matches 166 the new advertisement against the verified consumers' accounts (using a database connection over TCP, for example).

The targeted advertising system 100 displays 168 the advertisement in the consumers' personal web user interfaces (using a database connection over TCP, for example).

The targeted advertising system 100 sends 170 out the advertisement content over email (using IP/TCP protocols, for example).

The targeted advertising system 100 sends 172 out the advertisement content over mobile messaging (using GSM and IP/TCP protocols, for example).

Next, with reference to FIG. 1C, some further embodiments of the invention will be described. The server apparatus 198 implements the targeted advertising system 100 and its database 102, and the client apparatus 199 is implemented as the consumer computer 176 or the consumer mobile device 182. The server apparatus 198 comprises the processor 216, the memory 206 including the computer program 234 instructions 236, and the database 102. The memory 206 and the computer program 234 instructions 236 of the server apparatus 198 are configured to, with the processor 216, cause the server apparatus 198 to perform four operations.

First operation: to save 186 into the database 102 advertiser-set targeted consumer advertising with interest, location, and time as selection parameters for the targeted consumer. In an embodiment, the time selection parameter of the advertiser-set targeted consumer advertising is saved into the database 102 in such a manner that the time selection parameter comprises a time period, a moment of time, a recurring time period, a recurring moment of time, or a rule determining that the time selection parameter becomes valid for a predetermined amount of time after immediate consumer-triggered interest information is received from the client apparatus 199.

Second operation: to receive 190, 188/192, 196 immediate consumer-triggered interest information from the client apparatus 199 of the consumer, and receive location information determining the present location of the client apparatus 199, the immediate consumer-triggered interest information indicating immediate interest of the consumer in some good and/or service and/or brand and resulting from consumer interaction with a user interface 230 of the client apparatus 199.

There are numerous ways for the consumer to indicate his/her interests in real-time or almost in real-time. Consequently, the server apparatus 198 may be configured to receive the immediate consumer-triggered interest information from the client apparatus 199 as resulting from the current consumer interaction with the user interface 230 of the client apparatus 199
by selecting an icon indicating the interest in a specific type of good and/or service and/or brand, and/or
by dragging and dropping an icon indicating the interest in a specific type of good and/or service and/or brand, and/or
by selecting a user interface item indicating the interest in a specific type of good and/or service and/or brand (the user interface item may be a menu item, for example), and/or
by writing and thus indicating the interest in a specific type of good and/or service and/or brand, and/or
by reacting to a previous received targeted consumer advertising, and/or
by transmitting a response message to a previous received targeted consumer advertising, and/or
by reacting to or through at least one of the following: a Short Message Service SMS message, an Multimedia Message Service MMS message, an electronic mail message, a Twitter tweet, a personal page in the web, or a social media.

FIG. 4 illustrates the drag-and-drop approach. A part 400 of the user interface 230 of the client apparatus 199 includes two areas: a proposal area 402 including various interests, like for example car 404, health 406, sports 408, fashion 410, electronics 412, entertainment 414, and home 416; and a selected interests area 418. The consumer is interested in cars, which manifests itself as a drag-and-drop operation: the car icon 404 is dragged 420 from the proposal area 402 into the selected interests area 404 and dropped there.

As illustrated in FIG. 1C, the present location may be obtained 192, 196 from a positioning receiver 184 of the client apparatus 199, from 192, 194 a location service 180, or from some other way to implement the positioning of the client apparatus 199. The positioning receiver 184 may be a receiver of a global navigation satellite system, such as the Global Positioning System (GPS), the Global Navigation Satellite System (GLONASS), the Galileo Positioning System (Galileo), the Beidou Navigation System, or the Indian Regional Navigational Satellite System (IRNSS), for example. The positioning receiver 184 determines its location (longitude, latitude, and altitude) using signals transmitted from satellites orbiting Earth. Besides global navigation satellites, the positioning receiver 184 may also determine its location utilizing other known positioning techniques. It is well known that by receiving radio signals from several different base stations, the mobile phone may determine its location. The location service 180 may use some standard way described in the cellular radio network 178 specifications, such as a location-based service (LBS), for example. Another way to position the client apparatus 199 is also described in FIG. 1C: detecting the location of the closest node 174 (such as a router or a base station of the cellular network 178, for example) via which the client apparatus 199 is connected.

Third operation: search 186, in response to receiving the immediate consumer triggered interest information, from the database 102 for such advertiser-set targeted consumer advertising whose interest selection parameter matches the interest information, whose location selection parameter matches the location information, and whose time selection parameter matches the present time.

Fourth operation: transmit 188, 190/192, 196 the found instant targeted consumer advertising to the client apparatus 199.

In an embodiment, the second, the third and the fourth operations, i.e. receive the immediate consumer-triggered interest information and the location information, search for the targeted consumer advertising, and transmit the found instant targeted consumer advertising, are all performed in such a time frame that the consumer experiences the presentation of the found instant targeted consumer advertising in the client apparatus 199 as a result of the consumer indicating interest in some good and/or service and/or brand and resulting from the current consumer interaction with the user interface 230 of the client apparatus 199. This may be implemented by utilizing as the time frame a time period ending before detection of the closure of the current consumer interaction session, or a time period lasting less than five minutes, or a time period comprising only processing delays, or a time period comprising no artificial delays. In a sense, the instant targeted consumer advertising is created immediately, i.e. without too much such delay that would break the impression that the targeted consumer is a direct response for the consumer indicating his/her interests. The look-and-feel offered by the user interface 230 is such that the consumer feels as if his/her actions are directly met with a reaction in the form of targeted advertising. Such a direct gratification of his/her needs improves his/her motivation to study the contents of the advertising. Technically speaking, the technical nature of such an operation sequence is the targeting itself, i.e. with the targeting valuable data processing capacity and communication capacity is saved as only such advertising is performed that is deemed desirable by the consumer.

In an embodiment, the server apparatus 198 is configured to register both personal identification and contact information of the consumer; authenticate the consumer both by communicating electronically with the consumer utilizing the registered contact information and by authenticating electronically the identity of the consumer with the external authentication service 112; provide the instant targeted consumer advertising to the client apparatus 199 of the authenticated consumer by utilizing the registered contact information; and provide a fee for the consumer for receiving the instant targeted consumer advertising utilizing the registered contact information.

The client apparatus 199 for co-operation with the server apparatus 198 comprises the processor 216, the memory 206 including the computer program 234 instructions 236, and the user interface 230. The memory 206 and the computer program 234 instructions 236 are configured to, with the processor 216, cause the client apparatus 199 to perform four operations. First operation: trigger immediate consumer-triggered interest information relating to the advertiser-set targeted consumer advertising with the user interface 230. Second operation: transmit the immediate consumer-triggered interest information to the server apparatus 198. Third operation: receive instant targeted consumer advertising from the server apparatus 198. Fourth operation: present the received instant targeted consumer advertising with the user interface 230.

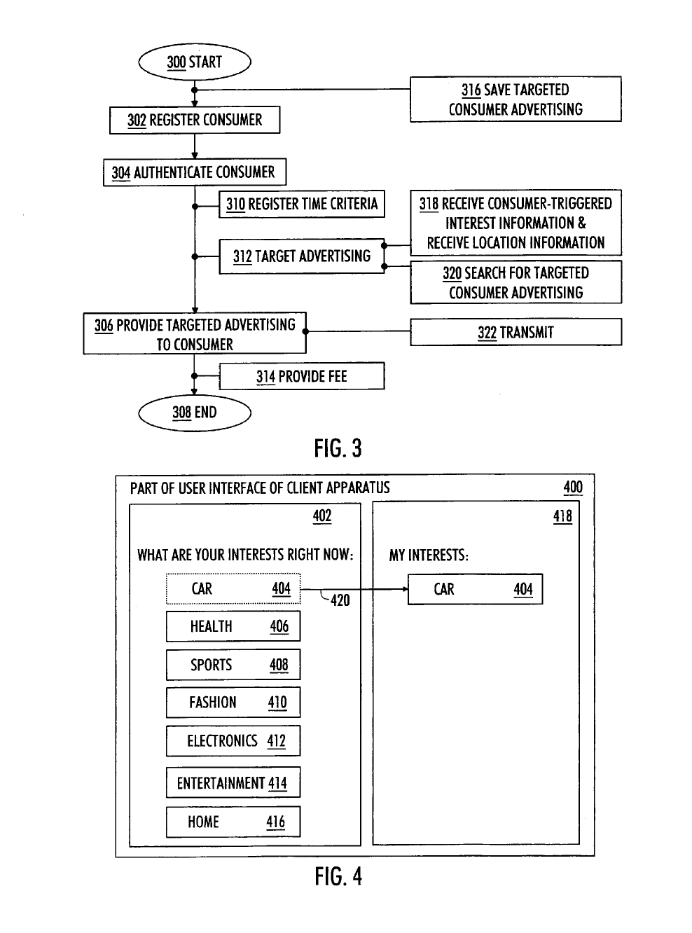

Next, a method will be described with reference to FIG. 3. The operations are in no absolute chronological order, and some of the operations may be performed simultaneously or in an order differing from the given one. Other functions, not described in this application, may also be executed between the operations or within the operations. Some of the operations or parts of the operations may also be left out or replaced by a corresponding operation or part of the operation. The method starts in 300. In 302, an electronic apparatus may register electronically both personal identification and contact information of a consumer. In 304, an electronic apparatus may authenticate electronically the consumer both by communicating electronically with the consumer utilizing the registered contact information and by authenticating electronically identity of the consumer with an external authentication service. In 306, an electronic apparatus may provide electronically targeted consumer advertising to the authenticated consumer utilizing the registered contact information. The method ends in 308. The embodiments of earlier described apparatuses may also be used to enhance the method. In an embodiment, a non-transitory computer-readable storage medium stores a computer program, comprising computer program instructions which, when loaded into an apparatus, cause the apparatus to perform the described operations. ‘An electronic apparatus’ may be a single apparatus, or the processing may be distributed among a number of electronic apparatuses, such as a server apparatus 198 and a client apparatus 199, depending on the implementation and the required processing capacity.

In an embodiment, the method further comprises: registering 310 electronically by an electronic apparatus time criteria for the targeted consumer advertising of the authenticated consumer; and targeting 312 by an electronic apparatus the targeted consumer advertising on the authenticated consumer utilizing the registered time criteria.

In another embodiment, the method further comprises: providing 314 by an electronic apparatus a fee for the authenticated consumer for receiving the targeted consumer advertising utilizing the registered contact information.

The method further comprises the following operations. Saving 316 advertiser-set targeted consumer advertising with interest, location, and time as selection parameters for the targeted consumer. Receiving 318 immediate consumer-triggered interest information from a client apparatus of a consumer, and receiving location information determining the present location of the client apparatus, the immediate consumer-triggered interest information indicating immediate interest of the consumer in some good and/or service and/or brand and resulting from consumer interaction with a user interface of the client apparatus. Searching 320, in response to receiving the immediate consumer triggered interest information, for such advertiser-set targeted consumer advertising whose interest selection parameter matches the interest information, whose location selection parameter matches the location information, and whose time selection parameter matches the present time. Transmitting 322 the found instant targeted consumer advertising to the client apparatus.

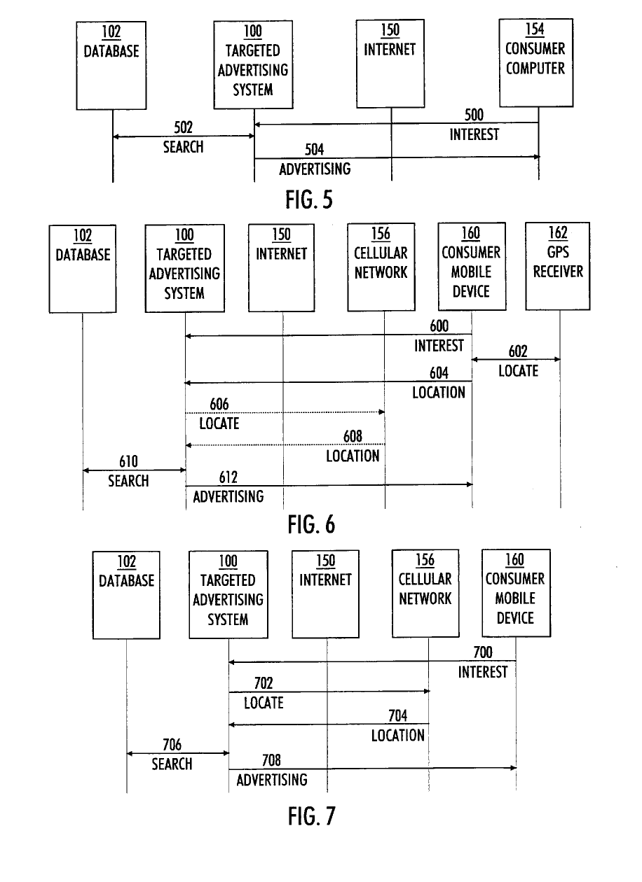

Next, with reference to FIGS. 5, 6, and 7, signal-sequence charts illustrate the communication between the various units.

Unique in the system is how the advertisement is targeted based on combination of the person, interests of the person, location, the moment of time the person shows interest or the moment of time the advertiser or the system expects the consumer to be interested, and the monetary incentive. Unique is also how especially the time (the very moment) and location are used in combination for targeting. When consumer indicates interest in shoes, for example, the system immediately locates the consumer and searches from the database the active shoe ads or campaigns from the neighborhood. The location sensitivity and time sensitivity is defined in the advertiser user interface during the creation of the ad or campaign. Another example is when the consumer gets as SMS or MMS message and responds to the message indicating interest. In this case, the operator locates the user and if the user is in the area defined by the advertiser, the user will get further ads from the system.

FIG. 5 illustrates a case where the consumer computer 154 is at home or in the office. The consumer drags 500 an icon in this computer screen to indicate interests, in shoes for example. The system locates the consumer through the zip code given in the registration or by detecting the location of the closest router via which the consumer is connected, and the system 100 checks 502 immediately if there is an advertisement in the database 102 that matches the consumers profile and location. If advertisement is found, the system sends 504 it to the consumer.

FIG. 6 illustrates a case where the client is a consumer mobile device 160. The consumer drags 600 an icon in this computer screen to indicate interests. The customer mobile device is located 604 by communicating 602 with the GPS receiver 162, or by communicating 606, 608 with the operator location system of the cellular network 156. The system 100 checks 610 immediately if there is an advertisement in the database 102 that matches the consumers profile and location. If advertisement is found, the system sends 612 it to the consumer.

FIG. 7 illustrates another case where the client is a consumer mobile device 160. The consumer mobile device receives an SMS or MMS ad and responses 700 to the ad. The system 702, 704 locates the consumer mobile terminal 160 by asking the operator location system of the cellular network 156, or by some other location technique. The system 100 checks 706 immediately if there is an advertisement in the database 102 that matches the consumers profile and location. If advertisement is found, the system sends 708 it to the consumer.

It will be obvious to a person skilled in the art that, as technology advances, the inventive concept can be implemented in various ways. The invention and its embodiments are not limited to the examples described above but may vary within the scope of the claims.

What is claimed is:

1. A server apparatus comprising a processor, a memory including computer program instructions, and a database, the memory and the computer program instructions being configured to, with the processor, cause the server apparatus to:
save into the database advertiser-set targeted consumer advertising with interest, location, and time as selection parameters for the targeted consumer;
receive immediate consumer-triggered interest information from a client apparatus of a consumer, and receive location information determining the present location of the client apparatus, the immediate consumer-triggered interest information indicating immediate interest of the consumer in some good and/or service and/or brand and resulting from consumer interaction with a user interface of the client apparatus;
search, in response to receiving the immediate consumer triggered interest information, from the database for such advertiser-set targeted consumer advertising whose interest selection parameter matches the interest information, whose location selection parameter matches the location information, and whose time selection parameter matches the present time; and
transmit the found instant targeted consumer advertising to the client apparatus.

2. The server apparatus of claim 1, wherein the memory and the computer program instructions are further configured to, with the processor, cause the server apparatus to:
save into the database the time selection parameter of the advertiser-set targeted consumer advertising in such a manner that the time selection parameter comprises a time period, a moment of time, a recurring time period, a recurring moment of time, or a rule determining that the time selection parameter becomes valid for a predetermined amount of time after immediate consumer-triggered interest information is received from the client apparatus.

3. The server apparatus of claim 1, wherein the memory and the computer program instructions are further configured to, with the processor, cause the server apparatus to:
receive the immediate consumer-triggered interest information and the location information, search for the targeted consumer advertising, and transmit the found instant targeted consumer advertising in such a time frame that the consumer experiences the presentation of the found instant targeted consumer advertising in the client apparatus as a result of the consumer indicating interest in some good and/or service and/or brand and resulting from the current consumer interaction with the user interface of the client apparatus.

4. The server apparatus of claim 3, wherein the memory and the computer program instructions are further configured to, with the processor, cause the server apparatus to:
utilize as the time frame a time period ending before detection of the closure of the current consumer interaction session, or a time period lasting less than five minutes, or a time period comprising only processing delays, or a time period comprising no artificial delays.

5. The server apparatus of claim 1, wherein the memory and the computer program instructions are further configured to, with the processor, cause the server apparatus to:
receive the immediate consumer-triggered interest information from the client apparatus as resulting from the current consumer interaction with the user interface of the client apparatus by selecting an icon indicating the interest in a specific type of good and/or service and/or brand, and/or by dragging and dropping an icon indicating the interest in a specific type of good and/or service and/or brand, and/or by selecting a user interface item indicating the interest in a specific type of good and/or service and/or brand, and/or by writing and thus indicating the interest in a specific type of good and/or service and/or brand, and/or by reacting to a previous received targeted consumer advertising, and/or by transmitting a response message to a previous received targeted consumer advertising, and/or by reacting to or through at least one of the following: a Short Message Service SMS message, an Multimedia Message Service MMS message, an electronic mail message, a Twitter tweet, a personal page in the web, or a social media.

6. The server apparatus of claim 1, wherein the memory and the computer program instructions are further configured to, with the processor, cause the server apparatus to:
register both personal identification and contact information of the consumer;
authenticate the consumer both by communicating electronically with the consumer utilizing the registered contact information and by authenticating electronically the identity of the consumer with an external authentication service;
provide the instant targeted consumer advertising to the client apparatus of the authenticated consumer by utilizing the registered contact information; and
provide a fee for the consumer for receiving the instant targeted consumer advertising utilizing the registered contact information.

7. A client apparatus for co-operation with a server apparatus, comprising a processor, a memory including computer program instructions, and a user interface, the memory and the computer program instructions being configured to, with the processor, cause the client apparatus to:
trigger immediate consumer-triggered interest information relating to the advertiser-set targeted consumer advertising with the user interface;
transmit the immediate consumer-triggered interest information to the server apparatus;
receive instant targeted consumer advertising from the server apparatus; and
present the received instant targeted consumer advertising with the user interface.

8. A method performed in at least one electronic apparatus comprising:
saving advertiser-set targeted consumer advertising with interest, location, and time as selection parameters for the targeted consumer;
receiving immediate consumer-triggered interest information from a client apparatus of a consumer, and receiving location information determining the present location of the client apparatus, the immediate consumer-triggered interest information indicating immediate interest of the consumer in some good and/or service and/or brand and resulting from consumer interaction with a user interface of the client apparatus;
searching, in response to receiving the immediate consumer triggered interest information, for such advertiser-set targeted consumer advertising whose interest selection parameter matches the interest information, whose location selection parameter matches the location information, and whose time selection parameter matches the present time; and
transmitting the found instant targeted consumer advertising to the client apparatus.

9. The method of claim 8, further comprising:
saving the time selection parameter of the advertiser-set targeted consumer advertising in such a manner that the time selection parameter comprises a time period, a moment of time, a recurring time period, a recurring moment of time, or a rule determining that the time selection parameter becomes valid for a predetermined amount of time after immediate consumer-triggered interest information is received from the client apparatus.

10. The method of claim 8, further comprising:
receiving the immediate consumer-triggered interest information and the location information, searching for the targeted consumer advertising, and transmitting the found instant targeted consumer advertising in such a time frame that the consumer experiences the presentation of the found instant targeted consumer advertising in the client apparatus as a result of the consumer indicating interest in some good and/or service and/or brand and resulting from the current consumer interaction with the user interface of the client apparatus.

11. The method of claim 10, further comprising:
utilizing as the time frame a time period ending before detection of the closure of the current consumer interaction session, or a time period lasting less than five minutes, or a time period comprising only processing delays, or a time period comprising no artificial delays.

12. The method of claim 8, further comprising:
receiving the immediate consumer-triggered interest information from the client apparatus as resulting from the current consumer interaction with the user interface of the client apparatus by selecting an icon indicating the interest in a specific type of good and/or service and/or brand, and/or by dragging and dropping an icon indicating the interest in a specific type of good and/or service and/or brand, and/or by selecting a user interface item indicating the interest in a specific type of good and/or service and/or brand, and/or by writing and thus indicating the interest in a specific type of good and/or service and/or brand, and/or by reacting to a previous received targeted consumer advertising, and/or by transmitting a response message to a previous received targeted consumer advertising, and/or by reacting to or through at least one of the following: a Short Message Service SMS message, an Multimedia Message Service MMS message, an electronic mail message, a Twitter tweet, a personal page in the web, or a social media.

13. The method of claim 8, further comprising:
registering both personal identification and contact information of the consumer;
authenticating the consumer both by communicating electronically with the consumer utilizing the registered contact information and by authenticating electronically the identity of the consumer with an external authentication service;
providing the instant targeted consumer advertising to the client apparatus of the authenticated consumer by utilizing the registered contact information; and
providing a fee for the consumer for receiving the instant targeted consumer advertising utilizing the registered contact information.

14. A non-transitory computer-readable storage medium storing a computer program, comprising computer program instructions which, when loaded into a server apparatus, cause the server apparatus to:
save advertiser-set targeted consumer advertising with interest, location, and time as selection parameters for the targeted consumer;
receive immediate consumer-triggered interest information from a client apparatus of a consumer, and receive location information determining the present location of the client apparatus, the immediate consumer-triggered interest information indicating immediate interest of the consumer in some good and/or service and/or brand and resulting from consumer interaction with a user interface of the client apparatus;
search, in response to receiving the immediate consumer triggered interest information, for such advertiser-set targeted consumer advertising whose interest selection parameter matches the interest information, whose location selection parameter matches the location information, and whose time selection parameter matches the present time; and
transmit the found instant targeted consumer advertising to the client apparatus.

15. A non-transitory computer-readable storage medium storing a computer program, comprising computer program instructions which, when loaded into a client apparatus, cause the client apparatus to:
trigger immediate consumer-triggered interest information relating to the advertiser-set targeted consumer advertising with a user interface;
transmit the immediate consumer-triggered interest information to a server apparatus;
receive instant targeted consumer advertising from the server apparatus; and
present the received instant targeted consumer advertising with the user interface.
